(19) United States
(12) Patent Application Publication
(10) Pub. No.: US 2019/0009984 A1
(43) Pub. Date: Jan. 10, 2019

(54) A STORAGE SYSTEM FOR STORING AND TRANSPORTING BINS

(71) Applicant: Autostore Technology AS, Nedre Vats (NO)

(72) Inventors: Ingvar Hognaland, Nedre Vats (NO); Ivar Fjeldheim, Haugesund (NO); Trond Austrheim, Etne (NO); Øystein Gjerdevik, Nedre Vats (NO)

(73) Assignee: Autostore Technology AS, Nedre Vats (NO)

(21) Appl. No.: 16/069,620

(22) PCT Filed: Nov. 15, 2016
(86) PCT No.: PCT/EP2016/077691

§ 371 Date: Jul. 12, 2018

(30) Foreign Application Priority Data
Jan. 14, 2016 (NO) 20160070

(51) Int. Cl. B65G 1/04; B65G 43/10; B65G 47/57

(52) U.S. Cl. CPC B65G 1/0464; B65G 2201/0258; B65G 47/57; B65G 43/10

(57) ABSTRACT

Method and systems for storing and transporting a plurality of storage bins to and from an upper and a lower location of a three dimensional storage grid, which is constructed by columns interconnected by top rails. The system includes a movable continuous chain running from the upper location to the lower location of said storage grid. The chain may have compartments fitted for holding the bins. Robot vehicles are running on the upper location of the storage grid. These are adapted for loading and unloading bins 4 from the compartments in the chain. A control system is configured for controlling loading and unloading of the bins from the compartments in the chain.

### TECHNICAL FIELD

The present invention relates to the field of automated logistics and storage systems. More specifically the invention relates to a system and method for effectively storing and transporting boxes from one location to another.

### BACKGROUND

The applicant's already known AutoStore© system is a storage system comprising a three dimensional storage grid wherein storage bins are stacked on top of each other to a certain height.

The storage grid is constructed as aluminium columns interconnected by top rails. A number of self-driven robot vehicles are moving horizontally on rails arranged on the top of the storage grid.

Each vehicle is equipped with hoisting gear for picking up, carrying, and placing bins that are stored in columns of the storage grid. Each bin may hold different types of articles.

The system also comprises delivery and/or supply stations, where one or several articles are picked out from a storage bin or where one or several items are filled into a storage bin.

When an article is to be retrieved from a bin, the robot vehicle is arranged to pick up the storage bin containing the article and transport it to a bin lift device. The bin lift device will transport the storage bin to a delivery station, where the article is retrieved from the storage bin. The storage bin, typically having remaining articles, is thereafter returned to the storage grid by means of the bin lift device and a robot vehicle.

The same procedure is used for refilling and storing items into the storage grid. First, items are filled into a storage bin at a supply station, normally at the same location as the delivery station. The bin lift device is then lifting the storage bin up to the upper level where a robot vehicle is transporting the storage bin into its destination in the storage grid.

A storage control and communication system may be used to monitor inventory, location of storage bins (within the storage grid and/or during transport), charge level of robot vehicles, etc. The storage control and communication system may further be provided with communication means for controlling the traffic of robot vehicles in order to avoid collision.

During busy periods several robot vehicles will operate simultaneously. One or more robots will then likely have to wait near the lift device before the lift is ready to be loaded or unloaded with a specific bin for delivery from or to a supply station. This will degrade the efficiency of the storage system.

This can be addressed by installing several lifts operating simultaneously. Such a configuration will however result in an undesired increase in system complexity, and each additional lift will occupy at least two columns of the storage grid, thereby reducing the available space.

Hence, it is an object of the present invention to provide a more time and cost efficient storage system.

### SHORT DESCRIPTION OF THE INVENTION

The present invention is set forth and characterized in the main claims.

In particular, the present invention comprises a storage system for storing and transporting a plurality of storage bins to and from an upper and a lower location of a three dimensional storage grid which is constructed by columns interconnected by top rails.

The system comprises a movable continuous chain running from the upper location to the lower location of said storage grid. The chain comprises compartments fitted for holding the bins.

The system further comprises robot vehicles running on the upper location of the storage grid, said vehicles are adapted for loading and unloading bins from the compartments in the chain.

A control system is adapted for controlling the loading and unloading of the bins from the compartments in the chain.

Further features and embodiments of the system are defined in the claims.

The invention is also defined by a method for storing and transporting a plurality of storage bins to and from an upper and a lower location of a three dimensional storage grid constructed by columns interconnected by top rails.

The method is characterised by providing a movable chain running from the upper to the lower location of said storage grid, and fitting said chain with compartments for holding the bins.

The method is further characterised by providing robot vehicles for running on the upper location of the storage grid, loading and unloading bins from the compartments in the chain by means of said vehicles.

A control system is then provided for controlling the loading and unloading of the bins to and from the compartments in the chain.

Further features of the method are defined in the claims.

### DETAILED DESCRIPTION

The invention will now be described in detail with reference to the figures, where:

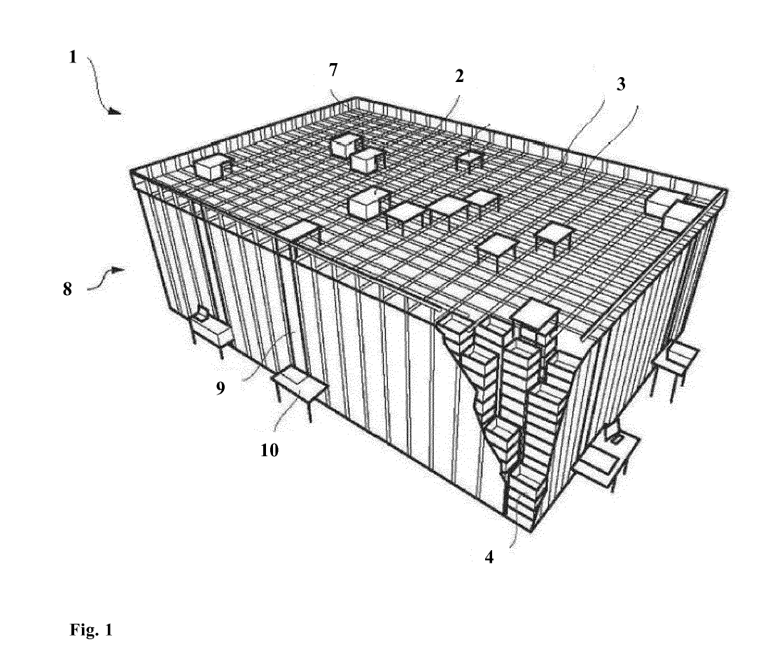

FIG. 1 shows an illustration of a storage grid comprising a transporting system according to the present invention, and

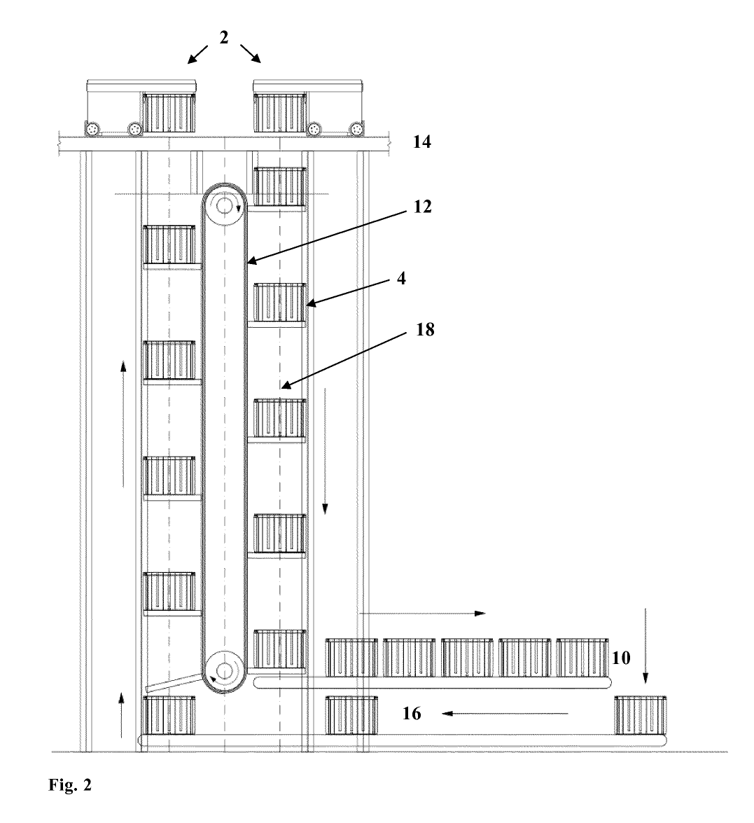

FIG. 2 shows lift device installed in the storage grid where the lift device comprises a chain of compartments for holding bins.

FIG. 1 shows the storage and transporting system 1 for storing and transporting a plurality of storage bins 4 to and from an upper and a lower location of a three dimensional storage grid 8 constructed by columns interconnected by top rails.

The system 1 comprises a plurality of robot vehicles 2 configured to move on dedicated supporting rails 3 and to receive a storage bin 4 from a storage column 7 within a bin storage grid 8. The system 1 has a dedicated bin lift device, shown in FIG. 2, comprising a movable continuous chain 12 with compartments 18 fitted for holding bins 4. Each compartment 18 is arranged to receive a storage bin 4 from a robot vehicle 2 operating at the top level of the storage system 1 and to convey the storage bin 4 down in a vertical direction to a supply station 10. The robot vehicle 2 retrieves a storage bin 4 by using a lifting frame connected to the robot vehicle 2 by a wire or belt. The lifting frame comprises attachment means for connection to a storage bin 4.

The movable continuous chain 12 comprising the compartments 18 is running from a upper location 14 to a lower location 16 of said storage grid 8.

In one embodiment the continuous chain 12 run continuously in the same direction for loading and unloading bins 4 to and from a supply station 10. In another embodiment the chain 12 may be controlled to adjust its speed and direction based on control signals. The arrows pointing upward and downwards in FIG. 2 indicates a direction of the chain 12. Bins 4 that are placed in compartments 18 mowing upwards are to be picked up and stored by means of a robot vehicle 2, and bins 4 in compartments 18 moving downwards contain bins with articles to be delivered at the supply station 10.

In one embodiment, the continuous movable chain 12 is installed in two columns of the storage grid 8. In another embodiment it is installed in three columns. Driving gear for driving the chain 12 can then be constructed more robust, and each bin can be loaded with more weight.

The system further comprises at least one, preferably several, robot vehicles 2 running on the upper location of the storage grid 8. These vehicles 2 are adapted for loading and unloading bins 4 from the compartments 18 in the chain.

The full potential of the invention is realized when several robot vehicles 2 are used during a period with heavy demand for articles stored in bins 4, or articles to be stored in bins 4.

The interaction between the movable continuous chain 12 and the robot vehicles 2 has to be controlled. The storage system 1 therefor further comprises a control system adapted for controlling the loading and unloading of the bins 4 to and from the compartments 18 in the chain.

This interaction requires very precise information of the location of each robot vehicle 2 relative to each compartment 18 of the chain.

According to one embodiment of the invention this is achieved by equipping the system 1 with detecting means for detecting the position of the compartments 18 of the movable chain relative to the upper location on the storage grid 8 where bins 4 are loaded or unloaded. Different types of sensor may be used for this purpose, e.g.

optical or magnetic sensors.

The upper location on the storage grid 8 is where the robot vehicles 2 are operating. When an article is ordered, the bin 4 holding the article will be picked up by a mobile vehicle 2 and placed in a compartment 18 of the chain 12. This action has to be synchronised such that the bin 4 is placed in the compartment 18 only when the compartment 18 is fully exposed, i.e. open.

In one embodiment of the invention, the storage system 1 comprises is a master control system connected to a first control system controlling the movements and actions of each robot vehicle 2. It is further connected to a second control system controlling the movements of the movable chain. In this way the master control system may at least have information about the location and speed of each mobile vehicle 2 as well as the movements of the chain with compartments 18.

In a preferred embodiment, the master control system will adjust the speed of the continuous chain according to current speeds and locations of robot vehicles 2 picking up or delivering bins 4 to and from compartments 18 of the chain. The traffic of robot vehicles 2 is determined by current demand of articles related to storing and ordering.

The master control system may also override the control system of the robot vehicles 2 for optimizing and synchronising movements of the vehicles 2 relative to speed of the chain and the position of compartments 18 ready to be loaded or unloaded.

For optimal utilization of the capacity of the storage system 1, the master control system is connected to a sensor detecting the position of a compartment 18 relative to the upper location on the storage grid 8. The master control system can then control the speed of the movable chain relative to the positions of the robot vehicles 2 loading or unloading bins 4 to and from compartment 18 of the chain. In this way optimal speed of loading/unloading and utilization of each compartment 18 in the movable chain will be provided.

The master control system is connected to several other control systems. As already mentioned, it is connected to a first control system controlling the movements and actions of each robot vehicle 2, and a second control system controlling the movements of the movable chain 12. It is further connected to a storage control and communication system monitoring inventory of, and location of storage bins 4 within the storage grid 8.

Software running on the master control system will receive input from all systems connected to the master system and based in such input data control the movements of the continuous chain for optimal efficiency of transporting bins 4 to and from a delivery/supply station.

A robot vehicle 2 running on the top of the storage grid 8 may comprise a hoisting gear, for picking up, carrying, and placing bins 4, that is located on the side of the main body of the vehicle 2. This construction will cover the area of two columns. When such a vehicle 2 is to load/unload a bin 4 to and from a compartment 18 of the chain, the main body of the vehicle 2 will have to be positioned on top of a row next to a row carrying the continuous chain with the compartments 18.

In another embodiment requiring less area, a robot vehicle 2 may comprise a hoisting gear that is integrated in the main body of the robot vehicle 2. This construction will cover the area of one column. When such a vehicle 2 is to load or unload a bin 4 to and from a compartment 18 of the chain, the main body of the vehicle 2 will have to be positioned on top of a row carrying the continuous chain with the compartments 18. A vehicle 2 covering the area of only one column will provide a more flexible solution where other vehicles 2 will have access to all columns next to a vehicle 2.

Both type of robot vehicle 2 may operate in the storage system 1 according to the invention, including a mix of these.

In a fully operating system according to the present invention, the speed, start and stop of the continuous chain will be adjusted according to locations of the robot vehicles 2 picking up and delivering bins 4.

By reducing the number of bin lift devices used in the storage system to a minimum and even increasing the capacity of delivering and retrieving bins to and from a supply station, the present invention provides a solution that is faster and more cost efficient than prior solutions.

1. A storage system for storing and transporting a plurality of storage bins to and from an upper and a lower location of a three dimensional storage grid constructed by columns interconnected by top rails, the storage system comprising the three dimensional storage grid and further comprising:
a movable continuous chain running from the upper location of said three dimensional storage grid to the lower location of said three dimensional storage grid, said movable continuous chain comprises compartments fitted for holding the plurality of storage bins;
a plurality of robot vehicles running on a top of the three dimensional storage grid, wherein each robot vehicle comprises a hoisting gear, for picking up, carrying, and placing the plurality of storage bins, wherein the hoisting gear is located on a side of a main body of each robot vehicle or is integrated in the main body of each robot vehicle for loading and unloading the plurality of storage bins from the compartments in the movable continuous chain;
at least one sensor for detecting a position of the compartments of the movable continuous chain relative to the upper location on the three dimensional storage grid where the plurality of bins are loaded or unloaded; and
a control system for controlling the loading and unloading of the plurality of storage bins from the compartments in the movable continuous chain, the control system comprising a master controller connected to a first and a second control system, said first control system controlling the movements and actions of each robot vehicle, and said second control system controlling the movable continuous chain, and wherein the master controller is connected to said at least one sensor and is for controlling a speed of the movable continuous chain relative to positions of the plurality of robot vehicle, based on information of a location and a speed of each robot vehicle as well as movements of the movable continuous chain with compartments, for adjusting the speed of the movable continuous chain according to current speeds and locations of the plurality of robot vehicles picking up or delivering plurality of storage bins to and from compartments of the movable continuous chain, for providing optimal speed of loading/unloading and utilization of each compartment in the movable continuous chain.

2. The storage system according to claim 1, wherein the movable continuous chain is installed in two columns of the three dimensional storage grid.

3. The storage system according to claim 1, further comprising a software running on the master control system for receiving input from all systems connected to the master system and based on such input data, control the movements of the movable continuous chain for optimal efficiency of transporting the plurality of storage bins to and from a delivery station or supply station.

4. A method for storing and transporting a plurality of storage bins to and from an upper and a lower location of a three dimensional storage grid constructed by columns interconnected by top rails, the method comprising:
providing a movable continuous chain running from the upper location of said three dimensional storage grid to the lower location of said three dimensional storage grid, and fitting said movable continuous chain with compartments for holding the plurality of storage bins;
providing robot vehicles for running on the upper location of the three dimensional storage grid, wherein each robot vehicle comprises a hoisting gear, for picking up, carrying, and placing bins (4), that is located on a side of a main body of each robot vehicle or is integrated in the main body of each robot vehicle for loading and unloading the plurality of storage bins to and from the compartments in the movable continuous chain;
providing at least one sensor for detecting a position of the compartments of the movable continuous chain relative to the upper location on the three dimensional storage grid where the plurality of storage bins are loaded or unloaded;
providing a control system, comprising a master controller system connected to a first control system controlling movements and actions of each robot vehicle and a second control system for controlling movements of the movable continuous chain;
letting the master controller system control the first control system for controlling the movements and actions of each robot vehicle, and the second control system for controlling the movable continuous chain;
connecting the master controller system to the at least one sensor; and
letting the master controller system control a speed of the movable continuous chain relative to positions of the robot vehicles, based on information of a location and a speed of each robot vehicle as well as movements of the movable continuous chain with compartments, for adjusting the speed of the movable continuous chain according to current speeds and locations of the plurality of robot vehicles picking up or delivering plurality of storage bins to and from compartments of the movable continuous chain, for providing optimal speed of loading/unloading and utilization of each compartment in the movable continuous chain.

5. (canceled)

6. The method according to claim 4, by letting the storage system operate autonomously.

7. The storage system according to claim 2, further comprising a software running on the master control system for receiving input from all systems connected to the master system and based on such input data, control the movements of the movable continuous chain for optimal efficiency of transporting the plurality of storage bins to and from a delivery station or supply station.
